(19) United States
(12) Patent Application Publication
(10) Pub. No.: US 2021/0192139 A1
(43) Pub. Date: Jun. 24, 2021

(54) LANGUAGE PROCESSING DEVICE, LANGUAGE PROCESSING SYSTEM AND LANGUAGE PROCESSING METHOD

(71) Applicant: Mitsubishi Electric Corporation, Tokyo (JP)

(72) Inventor: Hideaki JOKO, Tokyo (JP)

(73) Assignee: Mitsubishi Electric Corporation, Tokyo (JP)

(21) Appl. No.: 16/755,836

(22) PCT Filed: Nov. 29, 2017
(86) PCT No.: PCT/JP2017/042829

§ 371 Date: Apr. 13, 2020

(51) Int. Cl. G06F 40/30; G06F 40/268; G06F 40/279; G06F 16/33

(52) U.S. Cl. CPC G06F 40/30; G06F 40/268; G06F 16/3334; G06F 16/3347; G06F 40/279

(57) ABSTRACT

In a language processing device (2), a vector integrating unit (23) generates an integrated vector in which a Bag-of-Words vector corresponding to an input sentence and a semantic vector corresponding to the input sentence are integrated. A response sentence selecting unit (24) selects a response sentence corresponding to the input sentence from the questions/responses DB (25) on the basis of the integrated vector generated by the vector integrating unit (23).

### TECHNICAL FIELD

The present invention relates to a language processing device, a language processing system, and a language processing method.

### BACKGROUND ART

As technology for presenting necessary information from a large amount of information, there is question answering technology. An object of the question answering technology is to output information that the user needs without excess or omission by using, as input, words that a user normally uses as they are. When dealing with words that a user normally uses, it is important to appropriately handle unknown words included in a sentence to be processed, that is, words that are not used in a document having been prepared in advance.

For example, in conventional technology described in Non-Patent Literature 1, a sentence to be processed is represented by numerical vectors representing the meanings of a word and a sentence (hereinafter referred to as a semantic vector) by determining the context around the word and the sentence by machine learning using a large-scale corpus. Since a large-scale corpus used for generation of a semantic vector includes a large amount of vocabulary, there is an advantage that an unknown word is unlikely to be included in a sentence to be processed.

### CITATION LIST

### Non-Patent Literature

Non-Patent Literature 1: Tomas Mikolov, Kai Chen, Greg Corrado, and Jeffrey Dean, “Efficient Estimation of Word Representations in Vector Space”, ICLR 2013.

### SUMMARY OF INVENTION

### Technical Problem

The conventional technology described in Non-Patent Literature 1 addresses the problem of unknown words by using the large-scale corpus.

However, in the conventional technology described in Non-Patent Literature 1, even words and sentences that are different from each other are mapped to similar semantic vectors in a case where their surrounding contexts are similar. For this reason, there is a disadvantage that the meanings of a word and a sentence represented by the semantic vector become ambiguous and difficult to be distinguished.

For example in sentence A “Tell me about the storage period for frozen food in the freezer” and sentence B “Tell me about the storage period for frozen food in the ice making room,” although the different words “freezer” and “ice making room” are included, the context around “freezer” and the context around “ice making room” are the same. For this reason, in the conventional technology described in Non-Patent Literature 1, sentence A and sentence B are mapped to similar semantic vectors and thus are difficult to be distinguished. Unless sentence A and sentence Bare correctly distinguished, a correct response sentence cannot be selected when sentence A and sentence B are used as question sentences.

The present invention solves the above-mentioned disadvantage, and an object of the present invention is to obtain a language processing device, a language processing system, and a language processing method capable of selecting an appropriate response sentence corresponding to a sentence to be processed without obscuring the meaning of the sentence to be processed while dealing with the problem of unknown words.

### Solution to Problem

A language processing device according to the present invention includes a questions/responses database (hereinafter referred to as the questions/responses DB), a morphological analysis unit, a first vector generating unit, a second vector generating unit, a vector integrating unit, and a response sentence selecting unit. In the questions/responses DB, a plurality of question sentences and a plurality of response sentences are registered in association with each other. The morphological analysis unit performs morphological analysis on a sentence to be processed. The first vector generating unit has dimensions corresponding to words included in the sentence to be processed, and generates a Bag-of-Words vector (hereinafter referred to as a BoW vector), of which a component of a dimension is the number of times the word appears in the questions/responses DB, from the sentence that has been morphologically analyzed by the morphological analysis unit. The second vector generating unit generates a semantic vector representing the meaning of the sentence to be processed from the sentence that has been morphologically analyzed by the morphological analysis unit. The vector integrating unit generates an integrated vector obtained by integrating the BoW vector and the semantic vector. The response sentence selecting unit specifies a question sentence corresponding to the sentence to be processed from the questions/responses DB on the basis of the integrated vector generated by the vector integrating unit, and selects a response sentence corresponding to the specified question sentence.

### Advantageous Effects of Invention

According to the present invention, an integrated vector, which is obtained by integrating a BoW vector that can express a sentence by a vector without obscuring the meaning of the sentence but has an problem of unknown words and a semantic vector that can address the problem of unknown words but may obscure the meaning of the sentence, is used for selection of a response sentence. The language processing device is capable of selecting an appropriate response sentence corresponding to the sentence to be processed without obscuring the meaning of the sentence to be processed while addressing the problem of unknown words by referring to the integrated vector.

### BRIEF DESCRIPTION OF DRAWINGS

FIG. 1 is a block diagram illustrating a configuration of a language processing system according to a first embodiment of the invention.

FIG. 2 is a diagram illustrating an example of registered contents of a questions/responses DB.

FIG. 3A is a block diagram illustrating a hardware configuration for implementing the function of a language processing device according to the first embodiment.

FIG. 3B is a block diagram illustrating a hardware configuration for executing software that implements functions of the language processing device according to the first embodiment.

FIG. 4 is a flowchart illustrating a language processing method according to the first embodiment.

FIG. 5 is a flowchart illustrating morphological analysis processing.

FIG. 6 is a flowchart illustrating BoW vector generating processing.

FIG. 7 is a flowchart illustrating semantic vector generating processing.

FIG. 8 is a flowchart illustrating integrated vector generating processing.

FIG. 9 is a flowchart illustrating response sentence selecting processing.

FIG. 10 is a block diagram illustrating a configuration of a language processing system according to a second embodiment of the invention.

FIG. 11 is a flowchart illustrating a language processing method according to the second embodiment.

FIG. 12 is a flowchart illustrating important concept vector generating processing.

FIG. 13 is a flowchart illustrating integrated vector generating processing in the second embodiment.

FIG. 14 is a block diagram illustrating a configuration of a language processing system according to a third embodiment of the invention.

FIG. 15 is a flowchart illustrating a language processing method according to the third embodiment.

FIG. 16 is a flowchart illustrating unknown word rate calculating processing.

FIG. 17 is a flowchart illustrating weight adjustment processing.

FIG. 18 is a flowchart illustrating integrated vector generating processing in the third embodiment.

### DESCRIPTION OF EMBODIMENTS

To describe the present invention further in detail, embodiments for carrying out the invention will be described below with reference to the accompanying drawings.

### First Embodiment

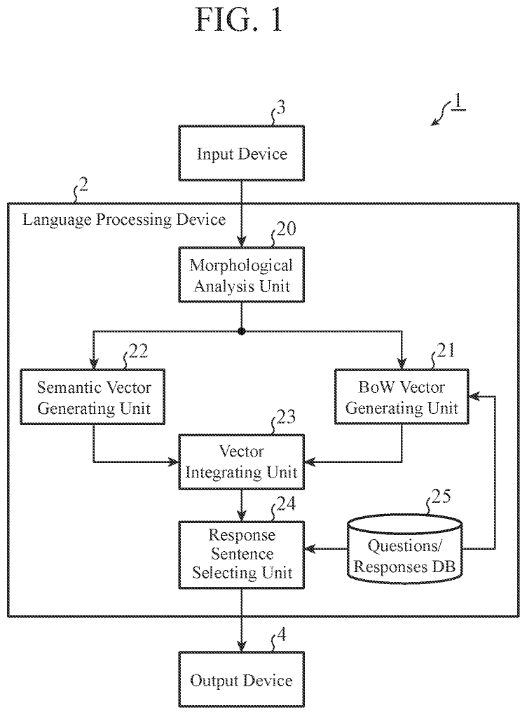

FIG. 1 is a block diagram illustrating a configuration of a language processing system 1 according to a first embodiment of the invention. The language processing system 1 selects and outputs a response sentence corresponding to a sentence input by a user, and includes a language processing device 2, an input device 3, and an output device 4.

The input device 3 accepts input of a sentence to be processed, and is implemented by, for example, a keyboard, a mouse, or a touch panel. The output device 4 outputs the response sentence selected by the language processing device 2, and is, for example, a display device that displays the response sentence or an audio output device (such as a speaker) that outputs the response sentence as voice.

The language processing device 2 selects the response sentence corresponding to the input sentence on the basis of a result of language processing of the sentence to be processed accepted by the input device 3 (hereinafter referred to as the input sentence). The language processing device 2 includes a morphological analysis unit 20, a BoW vector generating unit 21, a semantic vector generating unit 22, a vector integrating unit 23, a response sentence selecting unit 24, and a questions/responses DB 25. The morphological analysis unit 20 performs morphological analysis on the input sentence acquired from the input device 3.

The BoW vector generating unit 21 is a first vector generating unit that generates a BoW vector corresponding to the input sentence. The BoW vector is representation of a sentence in a vector representation method called Bag-to-Words. The BoW vector has a dimension corresponding to a word included in the input sentence, and the component of the dimension is the number of times the word corresponding to the dimension appears in the questions/responses DB 25. Note that the number of times of appearances of the word may be a value indicating whether the word is included in the input sentence. For example, in a case where a word appears at least once in the input sentence, the number of times of appearance is set to 1, and otherwise the number of times of appearance is set to 0.

The semantic vector generating unit 22 is a second vector generating unit that generates a semantic vector corresponding to the input sentence. Each dimension in the semantic vector corresponds to a certain concept, and a numerical value corresponding to a semantic distance from this concept is the component of the dimension. For example, the semantic vector generating unit 22 functions as a semantic vector generator. The semantic vector generator generates a semantic vector of an input sentence from the input sentence having been subjected to morphological analysis by machine learning using a large-scale corpus.

The vector integrating unit 23 generates an integrated vector obtained by integrating the BoW vector and the semantic vector. For example, the vector integrating unit 23 functions as a neural network. The neural network converts the BoW vector and the semantic vector into one integrated vector of any number of dimensions. That is, the integrated vector is a single vector that includes BoW vector components and semantic vector components.

The response sentence selecting unit 24 specifies a question sentence corresponding to the input sentence from the questions/responses DB 25 on the basis of the integrated vector, and selects a response sentence corresponding to the specified question sentence. For example, the response sentence selecting unit 24 functions as a response sentence selector. The response sentence selector is configured in advance by learning the correspondence relationship between the question sentence and a response sentence ID in the questions/responses DB 25. The response sentence selected by the response sentence selecting unit 24 is sent to the output device 4. The output device 4 outputs the response sentence selected by the response sentence selecting unit 24 visually or aurally.

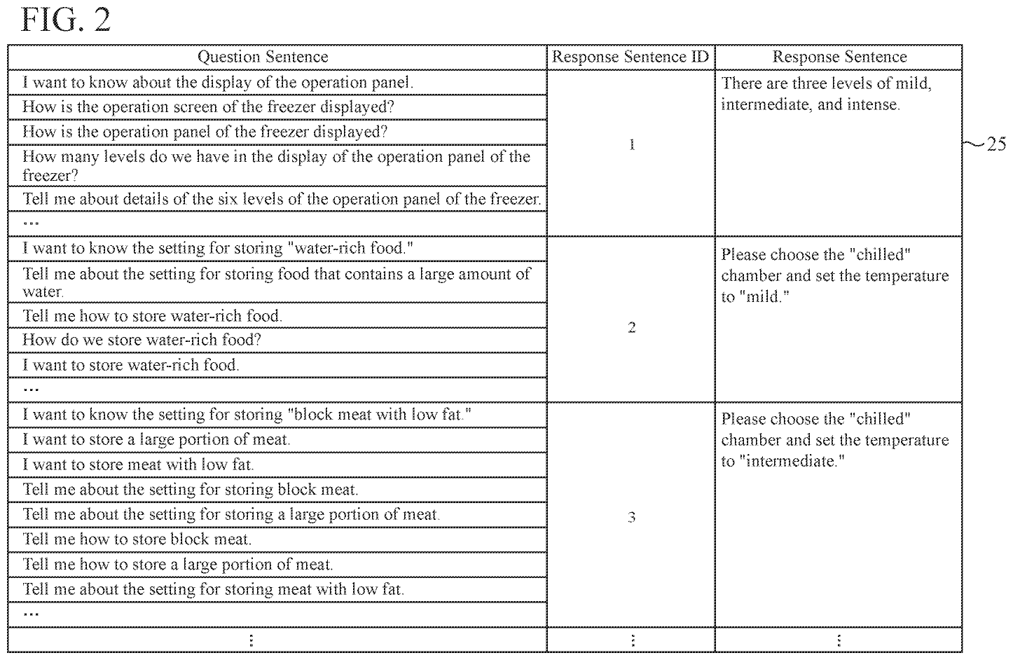

In the questions/responses DB 25, a plurality of question sentences and a plurality of response sentences are registered in association with each other. FIG. 2 is a diagram illustrating an example of registered contents of the questions/responses DB 25. As illustrated in FIG. 2, combinations of question sentences, response sentence IDs corresponding to the question sentences, and response sentences corresponding to the response sentence IDs are registered in the questions/responses DB 25. In the questions/responses DB 25, a plurality of question sentences may correspond to one response sentence ID.

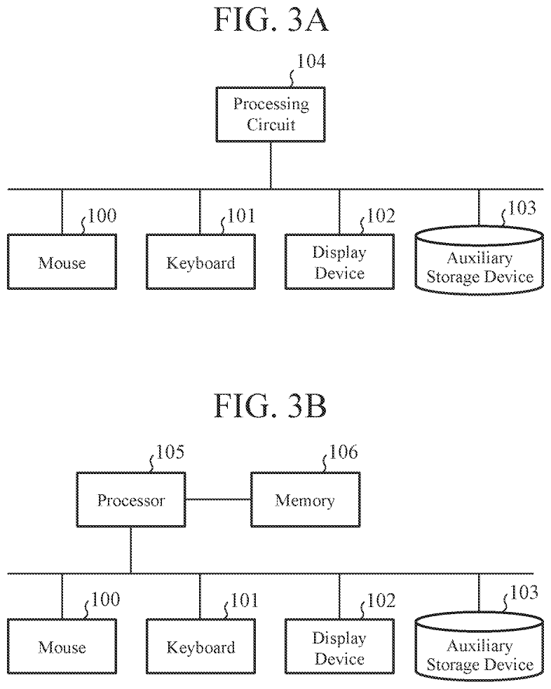

FIG. 3A is a block diagram illustrating a hardware configuration for implementing the function of the language processing device 2. FIG. 3B is a block diagram illustrating a hardware configuration for executing software that implements the function of the language processing device 2. In FIGS. 3A and 3B, a mouse 100 and a keyboard 101 correspond to the input device 3 illustrated in FIG. 1, and accept an input sentence. A display device 102 corresponds to the output device 4 illustrated in FIG. 1, and displays a response sentence corresponding to the input sentence. An auxiliary storage device 103 stores the data of the questions/responses DB 25. The auxiliary storage device 103 may be a storage device provided independently of the language processing device 2. For example, the language processing device 2 may use the auxiliary storage device 103 existing on a cloud server via a communication interface.

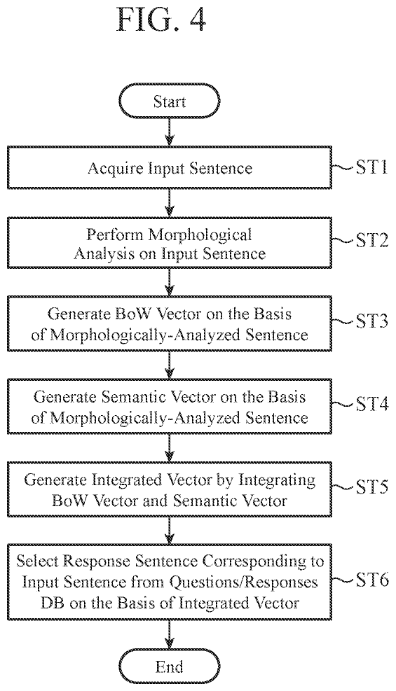

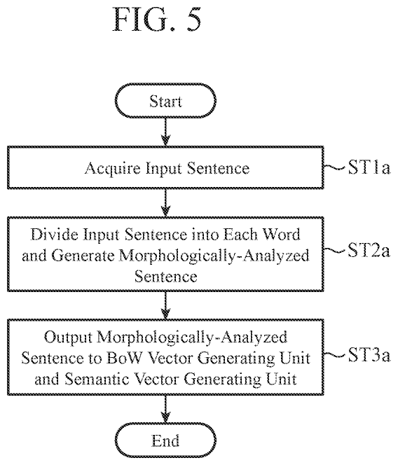

The functions of the morphological analysis unit 20, the BoW vector generating unit 21, the semantic vector generating unit 22, the vector integrating unit 23, and the response sentence selecting unit 24 in the language processing device 2 are implemented by a processing circuit. That is, the language processing device 2 includes a processing circuit for executing processing from step ST1 to step ST6 described later with reference to FIG. 4. The processing circuit may be dedicated hardware or a central processing unit (CPU) for executing a program stored in a memory.

In the case where the processing circuit is a processing circuit 104 of dedicated hardware illustrated in FIG. 3A, the processing circuit 104 may be a single circuit, a composite circuit, a programmed processor, a parallel programmed processor, an application specific integrated circuit (ASIC), a field-programmable gate array (FPGA), or a combination thereof, for example. The functions of the morphological analysis unit 20, the BoW vector generating unit 21, the semantic vector generating unit 22, the vector integrating unit 23, and the response sentence selecting unit 24 may be implemented by separate processing circuits, or may be collectively implemented by a single processing circuit.

In the case where the processing circuit is a processor 105 illustrated in FIG. 3B, the respective functions of the morphological analysis unit 20, the BoW vector generating unit 21, the semantic vector generating unit 22, the vector integrating unit 23, and the response sentence selecting unit 24 are implemented by software, firmware, or a combination of software and firmware. The software or the firmware is described as a program and is stored in a memory 106.

The processor 105 reads out and executes programs stored in the memory 106, whereby the each function of the morphological analysis unit 20, the BoW vector generating unit 21, the semantic vector generating unit 22, the vector integrating unit 23, and the response sentence selecting unit 24 are implemented.

That is, the language processing device 2 includes the memory 106 for storing programs execution of which by the processor 105 results in execution of processing from step ST1 to step ST6 illustrated in FIG. 4. These programs cause a computer to execute procedures or methods of the morphological analysis unit 20, the BoW vector generating unit 21, the semantic vector generating unit 22, the vector integrating unit 23, and the response sentence selecting unit 24.

The memory 106 may be a computer-readable storage medium storing the programs for causing a computer to function as the morphological analysis unit 20, the BoW vector generating unit 21, the semantic vector generating unit 22, the vector integrating unit 23, and the response sentence selecting unit 24.

The memory 106 corresponds to a nonvolatile or volatile semiconductor memory such as a random access memory (RAM), a read only memory (ROM), a flash memory, an erasable programmable read only memory (EPROM), or an electrically-EPROM (EEPROM); a magnetic disc, a flexible disc, an optical disc, a compact disc, a mini disc, a DVD, or the like.

Apart of the functions of the morphological analysis unit 20, the BoW vector generating unit 21, the semantic vector generating unit 22, the vector integrating unit 23, and the response sentence selecting unit 24 may be implemented by dedicated hardware with another part thereof implemented by software or firmware. For example, the functions of the morphological analysis unit 20, the BoW vector generating unit 21, and the semantic vector generating unit 22 are implemented by a processing circuit as dedicated hardware. The functions of the vector integrating unit 23 and the response sentence selecting unit 24 may be implemented by the processor 105 reading and executing programs stored in the memory 106. In this manner, the processing circuit can implement each function described above by hardware, software, firmware, or a combination thereof.

Next, the operation will be described.

FIG. 4 is a flowchart illustrating a language processing method according to the first embodiment.

The input device 3 acquires an input sentence (step ST1). Subsequently, the morphological analysis unit 20 acquires the input sentence from the input device 3, and performs morphological analysis on the input sentence (step ST2).

The BoW vector generating unit 21 generates a BoW vector corresponding to the input sentence from the sentence morphologically analyzed by the morphological analysis unit 20 (step ST3).

The semantic vector generating unit 22 generates a semantic vector corresponding to the input sentence from the sentence having been morphologically analyzed by the morphological analysis unit 20 (step ST4).

Next, the vector integrating unit 23 generates an integrated vector obtained by integrating the BoW vector generated by the BoW vector generating unit 21 and the semantic vector generated by the semantic vector generating unit 22 (step ST5).

The response sentence selecting unit 24 specifies a question sentence corresponding to the input sentence from the questions/responses DB 25 on the basis of the integrated vector generated by the vector integrating unit 23, and selects a response sentence corresponding to the specified question sentence (step ST6).

FIG. 5 is a flowchart illustrating the morphological analysis processing, and illustrates details of the processing in step ST2 of FIG. 4. The morphological analysis unit 20 acquires an input sentence from the input device 3 (step ST1a). The morphological analysis unit 20 generates a sentence that is morphologically analyzed by dividing the input sentence into morphemes and dividing them for each word (step ST2a). The morphological analysis unit 20 outputs the sentence that is morphologically analyzed to the BoW vector generating unit 21 and the semantic vector generating unit 22 (step ST3a).

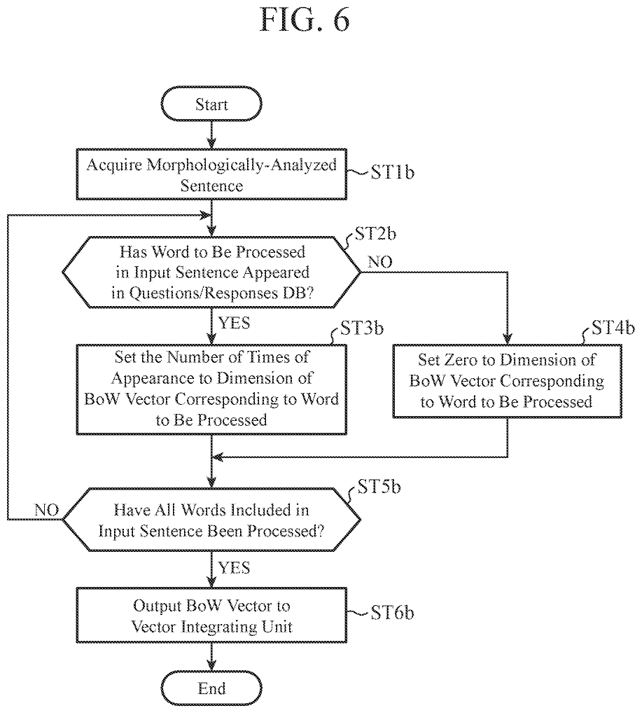

FIG. 6 is a flowchart illustrating the BoW vector generating processing and details of the processing in step ST3 of FIG. 4. The BoW vector generating unit 21 acquires the sentence that has been morphologically analyzed by the morphological analysis unit 20 (step ST1b). Next, the BoW vector generating unit 21 determines whether a word to be processed has appeared in the questions/responses DB 25 (step ST2b).

In a case where it is determined that the word to be processed appears in the questions/responses DB 25 (step ST2b: YES), the BoW vector generating unit 21 sets the number of times of appearance to the dimension of the BoW vector corresponding to the word to be processed (step ST3b).

In a case where it is determined that the word to be processed does not appear in the questions/responses DB 25 (step ST2b: NO), the BoW vector generating unit 21 sets “0” to the dimension of the BoW vector corresponding to the word to be processed (step ST4b).

Next, the BoW vector generating unit 21 confirms whether all words included in the input sentence have been processed (step ST5b). In a case where there is an unprocessed word among words included in the input sentence (step ST5b: NO), the BoW vector generating unit 21 returns to step ST2b and repeats the series of processing described above for processing an unprocessed word.

In a case where all the words included in the input sentence are processed (step ST5b: YES), the BoW vector generating unit 21 outputs the BoW vector to the vector integrating unit 23 (step ST6b).

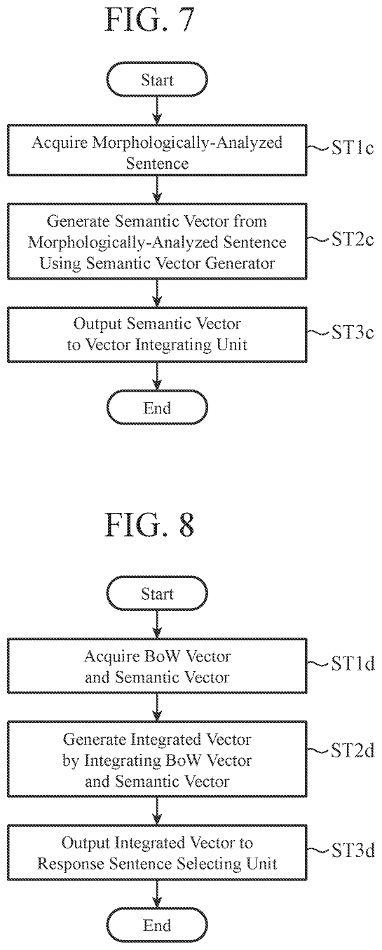

FIG. 7 is a flowchart illustrating the semantic vector generating processing and details of the processing in step ST4 of FIG. 4. The semantic vector generating unit 22 acquires the sentence that has been morphologically analyzed from the morphological analysis unit 20 (step ST1c).

The semantic vector generating unit 22 generates a semantic vector from the sentence that has been morphologically analyzed (step ST2c). In a case where the semantic vector generating unit 22 is a pre-configured semantic vector generator, the semantic vector generator generates, for example, a word vector representing the part of speech for each word included in the input sentence, and sets an average value of the word vector of the word included in the input sentence to the component of a dimension of the semantic vector corresponding to the word.

The semantic vector generating unit 22 outputs the semantic vector to the vector integrating unit 23 (step ST3c).

FIG. 8 is a flowchart illustrating the integrated vector generating processing and details of the processing in step ST5 of FIG. 4. The vector integrating unit 23 acquires the BoW vector from the BoW vector generating unit 21, and acquires the semantic vector from the semantic vector generating unit 22 (step ST1d).

Next, the vector integrating unit 23 integrates the BoW vector and the semantic vector to generate an integrated vector (step ST2d). The vector integrating unit 23 outputs the generated integrated vector to the response sentence selecting unit 24 (step ST3d).

In a case where the vector integrating unit 23 is a pre-configured neural network, the neural network converts the BoW vector and the semantic vector into one integrated vector of any number of dimensions. In a neural network, a plurality of nodes are hierarchized into an input layer, an intermediate layer, and an output layer, and a node in a preceding layer and a node in a subsequent layer are connected by an edge. The edge is set with a weight indicating the degree of connection between the nodes connected by the edge.

In the neural network, the integrated vector corresponding to the input sentence is generated by repeating operation using the weights on the dimension of the BoW vector and the dimension of the semantic vector being as input. The weights of the neural network is learned in advance using learning data by back-propagation so that integrated vector that allows an appropriate response sentence corresponding to the input sentence to be selected is generated from the questions/responses DB 25.

For example, the weight of the neural network for the sentence A “Tell me about the storage period for frozen food in the freezer” and the sentence B “Tell me about the storage period for frozen food in the ice making room” in BoW vector, which is integrated into an integrated vector, becomes larger for the dimension corresponding to the word “freezer” and the dimension corresponding to the word “ice making room”. As a result, in the BoW vector which is integrated into the integrated vector, the components of the dimensions corresponding to the words different between the sentence A and the sentence B are emphasized, thereby allowing the sentence A and the sentence B to be correctly distinguished.

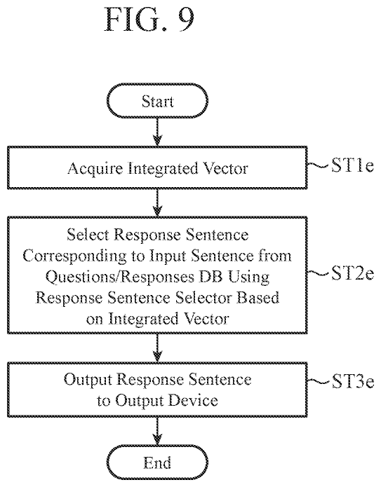

FIG. 9 is a flowchart illustrating the response sentence selection processing and details of the processing in step ST6 of FIG. 4. First, the response sentence selecting unit 24 acquires an integrated vector from the vector integrating unit 23 (step ST1e). Next, the response sentence selecting unit 24 selects a response sentence corresponding to the input sentence from the questions/responses DB 25 (step ST2e).

Even in a case where the number of unknown words included in the input sentence at the time of generation of the BoW vector is large, the response sentence selecting unit 24 can specify the meaning of the words by referring to a component of the semantic vector in the integrated vector. In addition, even in a case where the meaning of the sentence is ambiguous only with the semantic vector, the response sentence selecting unit 24 can specify the input sentence by referring to a component of the BoW vector in the integrated vector without obscuring the meaning of the input sentence.

For example, since the sentence A and the sentence B described above are correctly distinguished, the response sentence selecting unit 24 can select the correct response sentence corresponding to the sentence A and the correct response sentence corresponding to the sentence B.

Ina case where the response sentence selecting unit 24 is a pre-configured response sentence selector, the response sentence selector is configured in advance through learning of correspondence relationship between the question sentences and the response sentence IDs in the questions/responses DB 25.

For example, the morphological analysis unit 20 performs morphological analysis on each of the multiple question sentences registered in the questions/responses DB 25. The BoW vector generating unit 21 generates a BoW vector from the question sentence that has been morphologically analyzed, and the semantic vector generating unit 22 generates a semantic vector from the question sentence that has been morphologically analyzed. The vector integrating unit 23 integrates the BoW vector corresponding to the question sentence and the semantic vector corresponding to the question sentence to generate an integrated vector corresponding to the question sentence. The response sentence selector performs machine learning in advance on the correspondence relationship between the integrated vector corresponding to the question sentences and the response sentence IDs.

The response sentence generator configured in this manner can specify a response sentence ID corresponding to the input sentence from the integrated vector for the input sentence even for an unknown input sentence and select a response sentence corresponding to the specified response ID.

Alternatively, the response sentence selector may select a response sentence corresponding to a question sentence having the highest similarity to the input sentence. This similarity is calculated from the cosine similarity or the Euclidean distance of the integrated vector. The response sentence selecting unit 24 outputs the response sentence selected in step ST2e to the output device 4 (step ST3e). As a result, if the output device 4 is a display device, the response sentence is displayed, and if the output device 4 is an audio output device, the response sentence is output by voice.

As described above, in the language processing device 2 according to the first embodiment, the vector integrating unit 23 generates an integrated vector in which a BoW vector corresponding to an input sentence and a semantic vector corresponding to the input sentence are integrated. The response sentence selecting unit 24 selects a response sentence corresponding to the input sentence from the questions/responses DB 25 on the basis of the integrated vector generated by the vector integrating unit 23.

With this configuration, the language processing device 2 can select an appropriate response sentence corresponding to the input sentence without obscuring the meaning of the input sentence while addressing the problem of unknown words.

Since the language processing system 1 according to the first embodiment includes the language processing device 2, effects similar to the above can be obtained.

### Second Embodiment

Although a BoW vector is a vector of dimensions corresponding to various types of words, if it is limited to words included in a sentence to be processed, the BoW vector is often sparse with components of most dimensions being zero since words corresponding to the dimensions are not included in the sentence to be processed. In a semantic vector, components of dimensions are numerical values representing the meaning of various words, and thus the semantic vector is dense as compared to the BoW vector. In the first embodiment, sparse BoW vector and dense semantic vector are directly converted into one integrated vector by the neural network. For this reason, when learning by back-propagation is performed with a small amount of supervised data on the dimensions of the BoW vector, a phenomenon so-called “over-learning” may occur in which weights focused on the small amount of supervised data and thus is less likely to be generalized are learned. Therefore, in a second embodiment, the BoW vector is converted into denser vector before an integrated vector is generated in order to suppress occurrence of the over-learning.

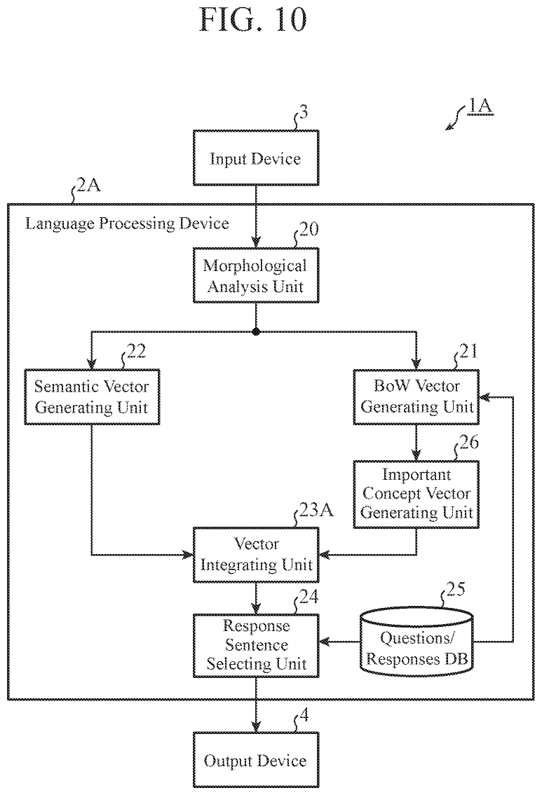

FIG. 10 is a block diagram illustrating a configuration of a language processing system 1A according to the second embodiment of the invention. In FIG. 10, the same components as those in FIG. 1 are denoted by the same symbol and descriptions thereof are omitted. The language processing system 1A selects and outputs a response sentence corresponding to a sentence input by a user, and includes a language processing device 2A, an input device 3, and an output device 4. The language processing device 2A selects a response sentence corresponding to an input sentence on the basis of a result of language processing of an input sentence, and includes a morphological analysis unit 20, a BoW vector generating unit 21, a semantic vector generating unit 22, a vector integrating unit 23A, a response sentence selecting unit 24, a questions/responses DB 25, and an important concept vector generating unit 26.

The vector integrating unit 23A generates an integrated vector in which an important concept vector generated by the important concept vector generating unit 26 and a semantic vector generated by the semantic vector generating unit 22 are integrated. For example, by a neural network pre-configured as the vector integrating unit 23A, the important concept vector and the semantic vector are converted into one integrated vector of any number of dimensions.

The important concept vector generating unit 26 is a third vector generating unit that generates an important concept vector from the BoW vector generated by the BoW vector generating unit 21. The important concept vector generating unit 26 functions as an important concept extractor. The important concept extractor calculates an important concept vector having a dimension corresponding to an important concept by multiplying each component of the BoW vector by a weight parameter. Here, a “concept” means “meaning” of a word or a sentence, and to be “important” means to be useful in selecting a response sentence. That is, an important concept means the meaning of a word or a sentence that is useful in selecting a response sentence. Note that the term “concept” is described in detail in Reference Literature 1 below.
Reference Literature 1: KASAHARA Kaname, MATSUZAWA Kazumitsu, ISHIKAWA Tsutomu, “A Method for Judgment of Semantic Similarity between Daily-used Words by Using Machine Readable Dictionaries”, IPSJ Journal, 38 (7), pp. 1272-1283 (1997).

The functions of the morphological analysis unit 20, the BoW vector generating unit 21, the semantic vector generating unit 22, the vector integrating unit 23A, the response sentence selecting unit 24, and the important concept vector generating unit 26 in the language processing device 2A are implemented by a processing circuit.

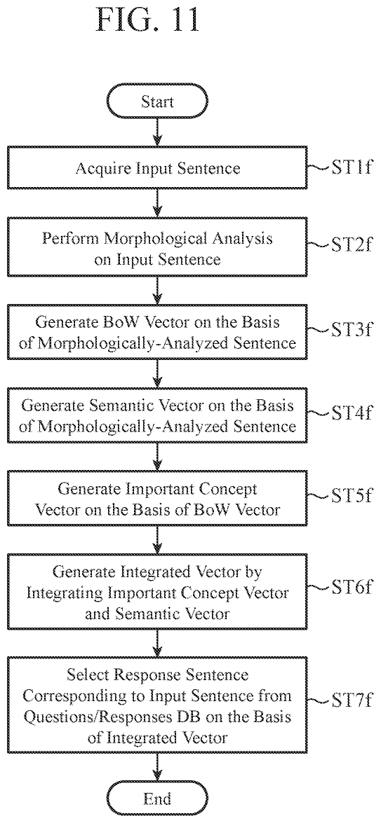

That is, the language processing device 2A includes a processing circuit for executing processing from step ST1f to step ST7f described later with reference to FIG. 11.

The processing circuit may be dedicated hardware or may be a processor that executes a program stored in a memory.

Next, the operation will be described.

FIG. 11 is a flowchart illustrating a language processing method according to the second embodiment.

The processing from step ST1f to step ST4f in FIG. 11 is the same as the processing from step ST1 to step ST4 in FIG. 4, and the processing in step ST7f in FIG. 11 is the same as the processing of step ST6 in FIG. 4, and thus description thereof is omitted.

The important concept vector generating unit 26 acquires the BoW vector from the BoW vector generating unit 21, and generates an important concept vector that is denser than the acquired BoW vector (step ST5f). The important concept vector generated by the important concept vector generating unit 26 is output to the vector integrating unit 23A. The vector integrating unit 23A generates an integrated vector in which the important concept vector and the semantic vector are integrated (step ST6f).

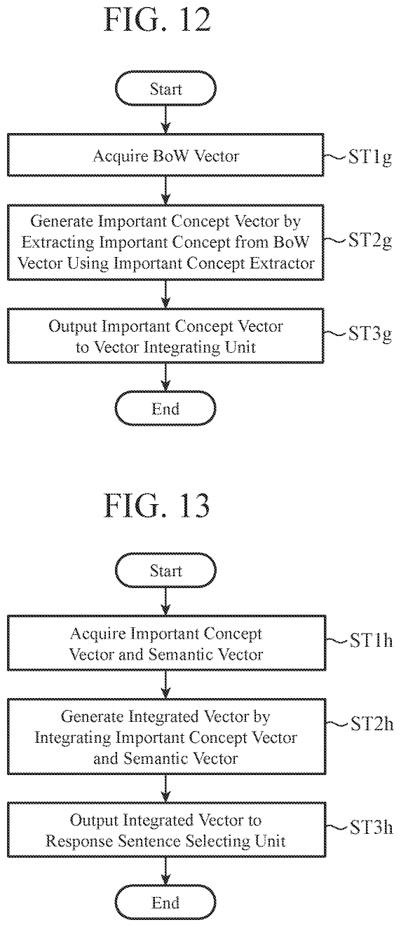

FIG. 12 is a flowchart illustrating important concept vector generating processing and details of the processing of step ST5f in FIG. 11. First, the important concept vector generating unit 26 acquires the BoW vector from the BoW vector generating unit 21 (step ST1g). Then, the important concept vector generating unit 26 extracts an important concept from the BoW vector and generates the important concept vector (step ST2g).

In a case where the important concept vector generating unit 26 is an important concept extractor, the important concept extractor multiplies each component of the BoW vector vₛ^{bow} corresponding to an input sentence s with weight parameters indicated by a matrix W according to the following equations (1). As a result, the BoW vector vₛ^{bow} is converted into the important concept vector vₛ^{con}. Here, the BoW vector corresponding to the input sentence s is represented as vₛ^{bow}×(x₁, x₂, . . . , xᵢ, . . . , x_{N}), and the important concept vector is represented as vₛ^{con}=(y₁, y₂, . . . , yⱼ, . . . , y_{D}).

$$W = ( \begin{matrix}{w}_{11} & ⋯ & {w}_{1 N} \\ ⋮ & ⋱ & ⋮ \\ {w}_{D 1} & ⋯ & {w}_{DN}\end{matrix} ) \\ {y}_{i} = \sum [ i ∈ N ] {w}_{ji} {x}_{i} \qquad ( 1 )$$

In the important concept vector vₛ^{con}, the component of a dimension corresponding to a word included in the input sentence s is weighted. The weight parameters may be determined using an autoencoder, principal component analysis (PCA), or singular value decomposition (SVD), or may be determined by back-propagation so that the word distribution of a response sentence is predicted. Alternatively, it may be determined manually.

The important concept vector generating unit 26 outputs the important concept vector vₛ^{con} to the vector integrating unit 23A (step ST3g).

FIG. 13 is a flowchart illustrating integrated vector generating processing in the second embodiment and details of the processing in step ST6f in FIG. 11. The vector integrating unit 23A acquires the important concept vector from the important concept vector generating unit 26, and acquires the semantic vector from the semantic vector generating unit 22 (step ST1h).

Next, the vector integrating unit 23A integrates the important concept vector and the semantic vector to generate an integrated vector (step ST2h). The vector integrating unit 23A outputs the integrated vector to the response sentence selecting unit 24 (step ST3h).

In a case where the vector integrating unit 23A is a pre-configured neural network, the neural network converts the important concept vector and the semantic vector into one integrated vector of any number of dimensions. As illustrated in the first embodiment, the weights in the neural network are learned in advance by back-propagation using learning data so that the integrated vector that allows a response sentence corresponding to the input sentence to be selected is generated.

As described above, the language processing device 2A according to the second embodiment includes the important concept vector generating unit 26 for generating an important concept vector in which each component of a BoW vector is weighted. The vector integrating unit 23A generates an integrated vector in which the important concept vector and the semantic vector are integrated. With this configuration, over-learning about the BoW vector is suppressed in the language processing device 2A.

Since the language processing system 1A according to the second embodiment includes the language processing device 2A, effects similar to the above can be obtained.

### Third Embodiment

In the second embodiment, the important concept vector and the semantic vector are integrated without considering the rate of unknown words in the input sentence (hereinafter referred to as the unknown word rate). For this reason, even in a case where the unknown word rate of an input sentence is high, the ratio that the response sentence selecting unit refers to the important concept vector and the semantic vector in the integrated vector does not change (hereinafter referred to as the reference ratio). In this case, there are cases where an appropriate response sentence cannot be selected if the response sentence selecting unit refers to, from among the important concept vector and the semantic vector in the integrated vector, a vector that does not sufficiently represent the input sentence due to unknown words included in the input sentence. In a third embodiment, therefore, in order to prevent deterioration of the accuracy of selection of a response sentence, the reference ratio between the important concept vector and the semantic vector is modified upon integration depending on the unknown word rate of the input sentence.

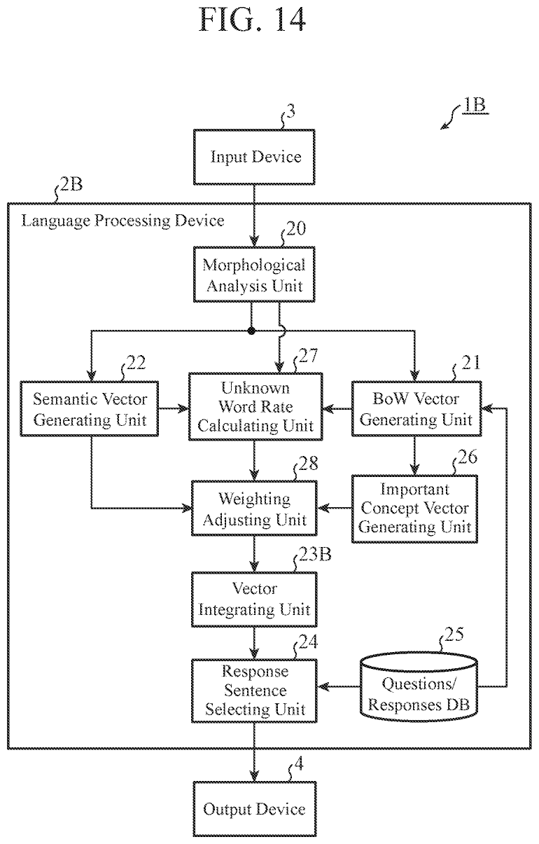

FIG. 14 is a block diagram illustrating a configuration of a language processing system 1B according to the third embodiment of the invention. In FIG. 14, the same components as those in FIGS. 1 and 10 are denoted by the same symbol and descriptions thereof are omitted. The language processing system 1B is a system that selects and outputs a response sentence corresponding to a sentence input by a user, and includes a language processing device 2B, an input device 3, and an output device 4. The language processing device 2B selects a response sentence corresponding to an input sentence on the basis of a result of language processing of an input sentence, and includes a morphological analysis unit 20, a BoW vector generating unit 21, a semantic vector generating unit 22, a vector integrating unit 23B, a response sentence selecting unit 24, a questions/responses DB 25, an important concept vector generating unit 26, an unknown word rate calculating unit 27, and a weighting adjusting unit 28.

The vector integrating unit 23B generates an integrated vector in which a weighted important concept vector and a weighted semantic vector acquired from the weighting adjusting unit 28 are integrated. The unknown word rate calculating unit 27 calculates an unknown word rate corresponding to a BoW vector and an unknown word rate corresponding to a semantic vector using the number of unknown words included in an input sentence at the time when the BoW vector has been generated and the number of unknown words included in the input sentence at the time when the semantic vector has been generated. The weighting adjusting unit 28 weights the important concept vector and the semantic vector on the basis of the unknown word rate corresponding to the BoW vector and the unknown word rate corresponding to the semantic vector.

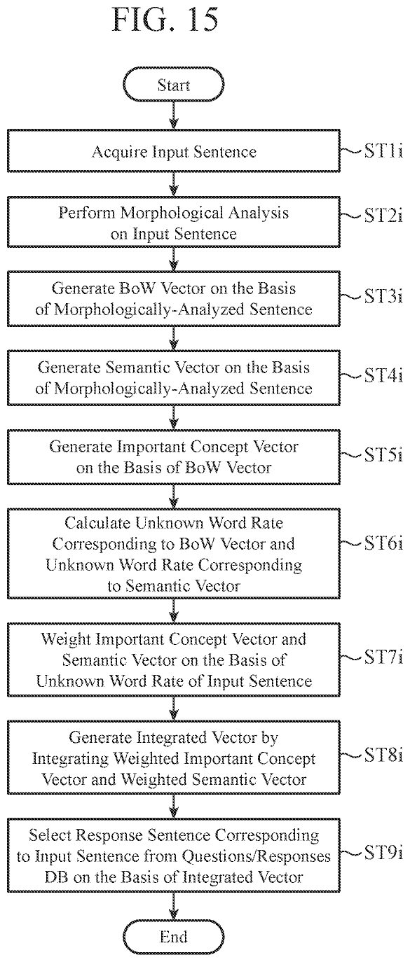

The functions of the morphological analysis unit 20, the BoW vector generating unit 21, the semantic vector generating unit 22, the vector integrating unit 23B, the response sentence selecting unit 24, the important concept vector generating unit 26, the unknown word rate calculating unit 27, and the weighting adjusting unit 28 in the language processing device 2B are implemented by a processing circuit. That is, the language processing device 2B includes a processing circuit for executing processing from step ST1i to step ST9i described later with reference to FIG. 15. The processing circuit may be dedicated hardware or may be a processor that executes a program stored in a memory.

Next, the operation will be described.

FIG. 15 is a flowchart illustrating a language processing method according to the third embodiment.

First, the morphological analysis unit 20 acquires an input sentence accepted by the input device 3 (step ST1i). The morphological analysis unit 20 performs morphological analysis on the input sentence (step ST2i). The input sentence that has been morphologically analyzed is output to the BoW vector generating unit 21 and the semantic vector generating unit 22. The morphological analysis unit 20 outputs the number of all the words included in the input sentence to the unknown word rate calculating unit 27.

The BoW vector generating unit 21 generates a BoW vector corresponding to the input sentence from the sentence that has been morphologically analyzed by the morphological analysis unit 20 (step ST3i). At this time, the BoW vector generating unit 21 outputs, to the unknown word rate calculating unit 27, the number of unknown words that are words not included in the questions/responses DB 25 among the words included in the input sentence.

The semantic vector generating unit 22 generates a semantic vector corresponding to the input sentence from the sentence having been morphologically analyzed by the morphological analysis unit 20 and outputs the semantic vector to the weighting adjusting unit 28 (step ST4i). At this point, the semantic vector generating unit 22 outputs, to the unknown word rate calculating unit 27, the number of unknown words corresponding to words that are not preregistered in a semantic vector generator among the words included in the input sentence.

Next, the important concept vector generating unit 26 generates an important concept vector obtained by making the BoW vector to be denser on the basis of the BoW vector acquired from the BoW vector generating unit 21 (step ST5i). The important concept vector generating unit 26 outputs the important concept vector to the weighting adjusting unit 28.

The unknown word rate calculating unit 27 calculates an unknown word rate corresponding to the BoW vector and an unknown word rate corresponding to the semantic vector using the number of all words in the input sentence, the number of unknown words included in the input sentence at the time when the BoW vector has been generated, and the number of unknown words included in the input sentence at the time when the semantic vector has been generated (step ST6i). The unknown word rate corresponding to the BoW vector and the unknown word rate corresponding to the semantic vector are output from the unknown word rate calculating unit 27 to the weighting adjusting unit 28.

The weighting adjusting unit 28 weights the important concept vector and the semantic vector on the basis of the unknown word rate corresponding to the BoW vector and the unknown word rate corresponding to the semantic vector acquired from the unknown word rate calculating unit 27 (step ST7i). When the unknown word rate corresponding to the BoW vector is large, the weights are adjusted so that the reference ratio of the semantic vector becomes high, and when the unknown word rate corresponding to the semantic vector is large, the weights are adjusted so that the reference ratio of the important concept vector becomes high.

The vector integrating unit 23B generates an integrated vector in which the weighted important concept vector and the weighted semantic vector acquired from the weighting adjusting unit 28 are integrated (step ST8i).

The response sentence selecting unit 24 selects a response sentence corresponding to the input sentence from the questions/responses DB 25 on the basis of the integrated vector generated by the vector integrating unit 23B (step ST9i). For example, the response sentence selecting unit 24 specifies a question sentence corresponding to the input sentence from the questions/responses DB 25 by referring to the important concept vector and the semantic vector in the integrated vector in accordance with each weight, and selects a response sentence corresponding to the specified question sentence.

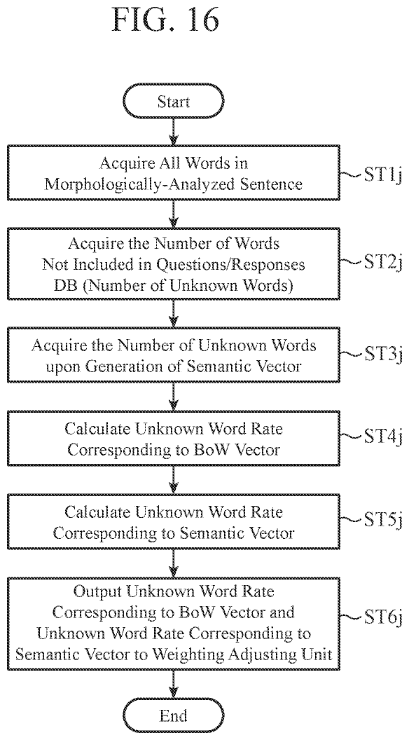

FIG. 16 is a flowchart illustrating unknown word rate calculating processing and details of the processing of step ST6i in FIG. 15. First, the unknown word rate calculating unit 27 acquires the total number of words Nₛ of an input sentence s having been morphologically analyzed from the morphological analysis unit 20 (step ST1j). The unknown word rate calculating unit 27 acquires, from the BoW vector generating unit 21, the number of unknown words Kₛ^{bow} at the time when the BoW vector has been generated among the words in the input sentence s (step ST2j). The unknown word rate calculating unit 27 acquires, from the semantic vector generating unit 22, the number of unknown words Kₛ^{w2v} at the time when the semantic vector has been generated among the words in the input sentence s (step ST3j).

The unknown word rate calculating unit 27 calculates an unknown word rate rₛ^{bow} corresponding to the BoW vector according to the following equation (2) using the total number of words Nₛ of the input sentence s and the number of unknown words Kₛ^{bo} corresponding to the BoW vector (step ST4j).

rₛ^{bow}=Kₛ^{bow}/Nₛ (2)

The unknown word rate calculating unit 27 calculates an unknown word rate rₛ^{w2v} corresponding to the semantic vector according to the following equation (3) using the total number of words Nₛ of the input sentence s and the number of unknown words Kₛ^{w2v} corresponding to the semantic vector (step ST5j). The number of unknown words Kₛ^{w2v} corresponds to the number of words not preregistered in the semantic vector generator.

rₛ^{w2v}=Kₛ^{w2v}/Nₛ (3)

The unknown word rate calculating unit 27 outputs the unknown word rate rₛ^{bow} corresponding to the BoW vector and the unknown word rate rₛ^{w2v} corresponding to the semantic vector to the weighting adjusting unit 28 (step ST6j).

Note that the unknown word rate rₛ^{bow} and the unknown word rate rₛ^{w2v} may be calculated in consideration of weights depending on the importance of words using tf-idf.

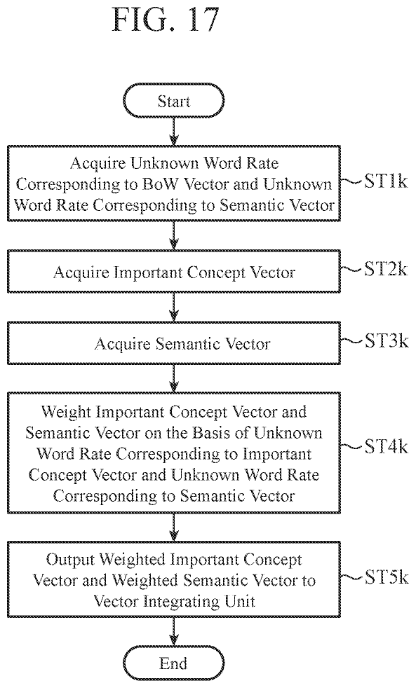

FIG. 17 is a flowchart illustrating weight adjusting processing and details of the processing of step ST7i in FIG. 15. First, the weighting adjusting unit 28 acquires the unknown word rate rₛ^{bow} corresponding to the BoW vector and the unknown word rate rₛ^{w2v} corresponding to the semantic vector from the unknown word rate calculating unit 27 (step ST1k).

The weighting adjusting unit 28 acquires the important concept vector vₛ^{con} from the important concept vector generating unit 26 (step ST2k). The weighting adjusting unit 28 acquires the semantic vector vₛ^{w2v} from the semantic vector generating unit 22 (step ST3k).

The weighting adjusting unit 28 weights the important concept vector vₛ^{con} and the semantic vector vₛ^{w2v} on the basis of the unknown word rate rₛ^{bow} corresponding to the BoW vector and the unknown word rate rₛ^{w2v} corresponding to the semantic vector (step ST4k). For example, the weighting adjusting unit 28 calculates a weight f(rₛ^{bow}, rₛ^{w2v}) of the important concept vector vₛ^{con} and a weight g(rₛ^{bow}, rₛ^{w2v}) of the semantic vector vₛ^{w2v} depending on the unknown word rate rₛ^{bow} and the unknown word rate rₛ^{w2v} The symbols f and g represent desired functions, and may be represented by the following equations (4) and (5). The coefficients a and b may be values set manually, or may be values determined by a neural network through learning by back-propagation.

f(x,y)=ax/(ax+by) (4)

g(x,y)=by/(ax+by) (5)

Next, the weighting adjusting unit 28 calculates a weighted important concept vector uₛ^{con} and a weighted semantic vector uₛ^{w2v} according to the following equations (6) and (7) using the weight f(rₛ^{bow}, rₛ^{w2v}) of the important concept vector vₛ^{con} and the weight g(rₛ^{bow}, rₛ^{w2v}) of the semantic vector vₛ^{w2v}.

uₛ^{con}=f(rₛ^{bow},rₛ^{w2v})vₛ^{con} (6)

uₛ^{w2}v=g(rₛ^{bow},rₛ^{w2v})vₛ^{w2v} (7)

For example, when the unknown word rate rₛ^{bow} in the input sentence s is larger than a threshold value, the weighting adjusting unit 28 adjusts the weight so that the reference ratio of the semantic vector vₛ^{w2v} becomes high. When the unknown word rate rₛ^{w2v} in the input sentence s is larger than the threshold value, the weighting adjusting unit 28 adjusts the weight so that the reference ratio of the important concept vector vₛ^{con} becomes high. The weighting adjusting unit 28 outputs the weighted important concept vector uₛ^{con} and the weighted semantic vector uₛ^{w2v} to the vector integrating unit 23B (step ST5k).

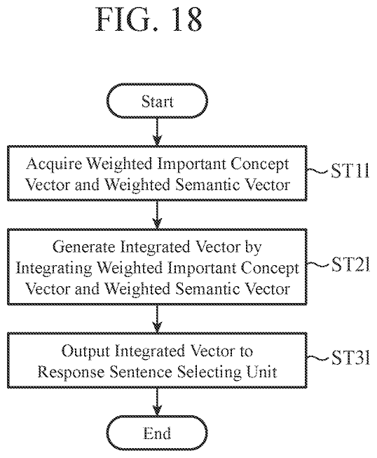

FIG. 18 is a flowchart illustrating integrated vector generating processing and details of the processing of step ST8i in FIG. 15. First, the vector integrating unit 23B acquires the weighted important concept vector uₛ^{con} and the weighted semantic vector uₛ^{w2v} from the weighting adjusting unit 28 (step ST1l). The vector integrating unit 23B generates an integrated vector in which the weighted important concept vector uₛ^{con} and the weighted semantic vector uₛ^{w2v} are integrated (step ST2l). For example, in a case where the vector integrating unit 23B is a neural network, the neural network converts the weighted important concept vector uₛ^{con} and the weighted semantic vector uₛ^{w2v} into one integrated vector of any number of dimensions. The vector integrating unit 23B outputs the integrated vector to the response sentence selecting unit 24 (step ST31).

Note that although the case has been described in the third embodiment in which the unknown word rate calculating unit 27 and the weighting adjusting unit 28 are applied to the configuration of the second embodiment, they may be applied to the configuration of the first embodiment.

For example, the weighting adjusting unit 28 may directly acquire the BoW vector from the BoW vector generating unit 21 and weight the BoW vector and the semantic vector on the basis of the unknown word rate corresponding to the BoW vector and the unknown word rate corresponding to the semantic vector. Also, in this manner, the reference ratio of the BoW vector and the semantic vector can be modified depending on the unknown word rate of the input sentence.

As described above, in the language processing device 2B according to the third embodiment, the unknown word rate calculating unit 27 calculates the unknown word rate rₛ^{bow} corresponding to the BoW vector and the unknown word rate rₛ^{w2v} corresponding to the semantic vector using the number of unknown words Kₛ^{bow} and the number of unknown words Kₛ^{w2v}. The weighting adjusting unit 28 weights the important concept vector vₛ^{con} and the semantic vector vₛ^{w2v} on the basis of the unknown word rate rₛ^{bow} and the unknown word rate rₛ^{w2v}. The vector integrating unit 23B generates an integrated vector in which the weighted important concept vector uₛ^{con} and the weighted semantic vector uₛ^{w2v} are integrated. With this configuration, the language processing device 2B can select an appropriate response sentence corresponding to the input sentence.

Since the language processing system 1B according to the third embodiment includes the language processing device 2B, effects similar to the above can be obtained.

Note that the present invention is not limited to the above embodiments, and the present invention may include a flexible combination of the individual embodiments, a modification of any component of the individual embodiments, or omission of any component in the individual embodiments within the scope of the present invention.

### INDUSTRIAL APPLICABILITY

The language processing device according to the present invention is capable of selecting an appropriate response sentence corresponding to a sentence to be processed without obscuring the meaning of the sentence to be processed while dealing with the problem of unknown words, and thus is applicable to various language processing systems applied with question answering technology.

### REFERENCE SIGNS LIST

1, 1A, 1B: language processing system, 2, 2A, 2B: language processing device, 3: input device, 4: output device, 20: morphological analysis unit, 21: BoW vector generating unit, 22: semantic vector generating unit, 23, 23A, 23B: vector integrating unit, 24: response sentence selecting unit, 25: questions/responses database (questions/responses DB), 26: important concept vector generating unit, 27: unknown word rate calculating unit, 28: weighting adjusting unit, 100: mouse, 101: keyboard, 102: display device, 103: auxiliary storage device, 104: processing circuit, 105: processor, 106: memory

1. A language processing device comprising:
processing circuitry performing a process to:
register a plurality of question sentences and a plurality of response sentences in association with each other;
perform morphological analysis on a sentence to be processed;
generate a Bag-of-Words vector having a dimension corresponding to a word included in the sentence to be processed from the sentence having been morphologically analyzed, a component of the dimension being the number of times of appearance of the word in the registration;
generate a semantic vector representing meaning of the sentence to be processed from the sentence having been morphologically analyzed;
generate an integrated vector in which the Bag-of-Words vector and the semantic vector are integrated; and
select one of the response sentences that corresponds to a specified question sentence by specifying the question sentence corresponding to the sentence to be processed from the registration on a basis of the integrated vector.

2. The language processing device according to claim 1, the process further comprising
generate an important concept vector in which each component of the Bag-of-Words vector is weighted,
wherein the process generates an integrated vector in which the important concept vector and the semantic vector are integrated.

3. The language processing device according to claim 2, the process further comprising:
calculate an unknown word rate corresponding to the Bag-of-Words vector and an unknown word rate corresponding to the semantic vector using the number of unknown words included in the sentence to be processed at the time of generation of the Bag-of-Words vector and the number of unknown words included in the sentence to be processed at the time of generation of the semantic vector; and
adjust weighting of vectors on a basis of the unknown word rate corresponding to the Bag-of-Words vector and the unknown word rate corresponding to the semantic vector,
wherein the process generates an integrated vector of vectors that has been weight-adjusted.

4. A language processing system comprising:
the language processing device according to claim 1;
an input device to accept input of the sentence to be processed; and
an output device to output the response sentence selected by the language processing device.

5. A language processing method of a language processing device comprising a questions/responses database in which a plurality of question sentences and a plurality of response sentences are registered in association with each other, the language processing method comprising:
performing morphological analysis on a sentence to be processed;
generating a Bag-of-Words vector having a dimension corresponding to a word included in the sentence to be processed from the sentence having been morphologically analyzed, a component of the dimension being the number of times of appearance of the word in the questions/responses database;
generating a semantic vector representing meaning of the sentence to be processed from the sentence having been morphologically analyzed;
generating an integrated vector in which the Bag-of-Words vector and the semantic vector are integrated; and
selecting one of the response sentences that corresponds to a specified question sentence by specifying the question sentence corresponding to the sentence to be processed from the questions/responses database on a basis of the integrated vector.

6. The language processing method according to claim 5, further comprising
generating an important concept vector in which a component of the Bag-of-Words vector is weighted,
wherein the steps generate an integrated vector in which the important concept vector and the semantic vector are integrated.

7. The language processing method according to claim 5, further comprising:
calculating an unknown word rate corresponding to the Bag-of-Words vector and an unknown word rate corresponding to the semantic vector using the number of unknown words included in the sentence to be processed at the time of generation of the Bag-of-Words vector and the number of unknown words included in the sentence to be processed at the time of generation of the semantic vector; and
adjusting weighting of vectors on a basis of the unknown word rate corresponding to the Bag-of-Words vector and the unknown word rate corresponding to the semantic vector,
wherein the steps generates an integrated vector of vectors that has been weight-adjusted.
